(19) United States
(12) Patent Application Publication
(10) Pub. No.: US 2008/0239911 A1
(43) Pub. Date: Oct. 2, 2008

(54) Parameter Variation Before Closing Radial Control Loop

(75) Inventors: Jeroen Arnoldus Leonardus Johannes Raaymakers, Eindhoven (NL); Tony Petrus Van Endert, Eindhoven (NL); Marcel M.H. Van Houtum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,765

(22) PCT Filed: Aug. 30, 2006
(86) PCT No.: PCT/IB06/53004

§ 371 Date: Mar. 5, 2008

(30) Foreign Application Priority Data
Sep. 8, 2005 (EP) 05108240.2

(51) Int. Cl. G11B 20/18

(52) U.S. Cl. 369/53.23

(57) ABSTRACT

The invention relates to a method of optimizing an optical drive system 101 capable of recording and/or reproducing data to and from an optical carrier 102, such as the high number of different types present e.g. a CD, DVD-SL, DVD-DL, HD-DVD or BD carrier More specifically, the invention relates to improved radial tracking error signal in the optical drive system and thereby alternatively or additionally also improved carrier recognition in the optical drive system. Disc recognition may be a cumbersome procedure due to influences such as the high number of carrier types present, the tolerances specified for and quality of the carriers, the tolerances within the optical system. E.g. a method and a system is disclosed where one or more parameters are varied 234 and one or more signals are evaluated 232 and based on the evaluation one or more parameters may be provided with a new setting before closing a radial control loop 218 in order to obtain an improved radial tracking error signal and/or improved carrier recognition.

The invention relates to a method of optimizing an optical drive system capable of recording and/or reproducing data to and from an optical carrier, such as e.g. a CD, DVD-SL, DVD-DL, HD-DVD or BD carrier. More specifically, the invention relates to improved radial tracking error signal in the optical drive system and thereby alternatively or additionally also improved carrier recognition in the optical drive system. The invention also relates to a corresponding optical drive system, and to computer readable code for implementing the method.

In optical drives for recording and/or reproducing of data to and/or from an optical carrier, a servo system is applied for keeping a focused beam of e.g. laser light from an optical pickup unit (OPU) on a desired track of the optical carrier. A radial control loop of the servo system allows the laser light to accurately follow the tracks on the optical carrier to ensure a reliable recording of data in the tracks or a stable readout of data from the tracks. A focus control loop of the servo system allows the laser light to be properly focused on the optical carrier.

Specifically, radial tracking is normally performed based on a closed radial control loop that uses a radial error signal (RE), i.e. a measure of the deviation of the actual radial position of the laser light from a target radial position obtained from reflected light of the optical carrier. A few well known tracking methods include the push pull (PP) method for rewriteable/recordable optical carriers with guide grooves, so-called pre-grooves, and the differential phase detection (DPD) method for optical carriers of the read-only memory (ROM) format.

Since the introduction of CD the number of carrier types is increasing. Carrier types such as CD, DVD, DVD-r(w), DVD+r(w), DVD-RAM, BD, HD-DVD are all commonly used. Most carrier types are also available in both single layer (SL) and double or dual layer (DL) variants. Additionally, carrier types with four layers are already shown to be feasible for a Blu Ray carrier or disc (BD).

Another trend is that the number of parameters to be calibrated in optical drives is increasing and in nowadays drives it is needed to adjust parameters such as focus offset, radial tilt, spherical aberration and tangential tilt to guaranty a proper servo, read and/or write performance.

All the carrier variants and parameters may also complicate carrier recognition, which is part of all optical drives. Alternatively or additionally all the carrier variants and parameters and quality of the carrier may lead to a slow recognition or even not recognizing the carrier type associated with the optical drive. The radial error signal is normally comprised in the signal(s) used when providing the carrier recognition.

In the U.S. patent publication US 2004/0027937 it is disclosed that an optical carrier is inserted, followed by determining the kind of optical carrier. Hereafter tracking servo and focus servo compensation is provided. The focus servo compensation is provided when the tracking loop is turned on.

In the view of the present inventors this solution does not, e.g. due to the compensation being provided after the carrier recognition, provide improved carrier recognition and does not provide an improved radial tracking error signal used for the carrier recognition.

Therefore, the inventors of the present invention have appreciated that an improved radial tracking error signal and improved carrier recognition is of benefit, and has in consequence devised the present invention.

The present invention seeks to provide an improved radial tracking error signal and/or improved carrier recognition. Preferably, the invention alleviates, mitigates or eliminates one or more of the above or other disadvantages singly or in any combination. In particular, it may be seen as an object of the present invention to provide a method of operating an optical drive and an optical drive that provides an improved radial tracking error signal and/or provides improved carrier recognition.

Accordingly there is provided, in a first aspect a method of optimizing a radial tracking error signal of an optical drive, the method comprising the steps of

generating one or more signals, the signals being dependent on one or more preset parameters and

evaluating the one or more signals and

varying a setting of the one or more of the preset parameters and

determining an optimal setting of the one or more preset parameters and setting the parameters to the optimal setting in response to the one or more signals before closing the radial control loop and before an optical carrier recognition and hereby

obtaining an optimal radial tracking error signal before closing a radial control loop and before optical carrier recognition.

A method of optimizing a radial tracking of an optical drive is thus provided which is suitable for an optical drive system for reading from and/or writing to an optical carrier associated with the optical drive. The optical carrier may also be referred to as the disc.

During the carrier recognition procedure the carrier is recognized based on physical and logical properties of the carrier. The first phase of this procedure is aimed to catch focus on the carrier. After catching focus on the carrier the carrier type is normally not known. Generally, it is normally also not known if a SL carrier or a DL carrier is associated with the optical drive. In the case of a DL carrier, it is normally not known on which layer a focus capture occurred. The next step is to close the radial control loop. It has been found that a reliable closing of the radial control loop can only be provided properly based on an optimal radial error signal.

The quality of a radial error signal is significantly affected by the setting of the one or more preset parameters. As an example a tolerance on cover layer thickness variation for a Blu-Ray carrier may be specified to +/−5 μm. If a means for obtaining a substantially collimated radiation beam positioning accuracy of +/−3 μm is assumed, the total accuracy between carriers can be +/−8 μm. Such a tolerance may provide at least one error in one of the preset parameters. The at least one error will significantly affect the radial error signal.

Amplitude and modulation of the radial error signal on e.g. a DVD with double layers heavily depends on the focus offset. If e.g. the preset focus offset value does not correspond with the actual layer, e.g. the amplitude of the radial error signal or a signal indicative thereof will decrease significantly. If these effects are neglected when closing the radial control loop then a carrier recognition branch may take wrong decisions based on the amplitude of the radial error signal or because of a failure to detect a valid wobble signal. The wobble signal is generated from the same signal as the radial error signal at least for a push-pull signal.

One possible advantage by the present invention may therefore be that the radial tracking error signal is optimized by determining an optimal setting of the preset parameters according to claim 1.

Another possible advantage by optimizing the setting(s) of the parameter(s) while the radial control loop is still open may be that a carrier recognition procedure after closing the radial control loop is provided on the best possible setting(s) of the parameter(s) on basis of the actual carrier and the actual drive system and hereby the radial tracking and/or the carrier recognition is improved.

Another possible advantage by operating the optical drive according to claim 1 may be that a correct carrier type can be determined even when the carrier is having a poor quality and/or when e.g. presettings of the optical drive focus control loop (and hereby settings of e.g. physical positions within the optical drive) and/or presettings elsewhere in the optical drive has been optimized to the present carrier.

A still further advantage by operating the optical drive according to claim 1 may be that by varying one or more parameters the correct carrier type may be determined as fast as possible instead of e.g. trying all carrier types and e.g. hereafter only being able to conclude that the present carrier is not readable and/or not writeable.

When the optimal radial error signal is also achieved before the carrier recognition one possible advantage may alternatively or additionally be that improved carrier recognition based on the radial error signal is provided.

When according to claim 2 the one or more preset parameters comprises one or more parameters useable to adjust the performance of the optical drive in response to characteristics of the optical drive and/or in response to characteristics of an optical carrier associated with the optical drive one possible advantage may be that all parameters having influence on the radial error signal may be set and/or adjusted in e.g. the focus control loop and/or elsewhere in the optical drive before closing the radial control loop and hereby improving the radial error signal already during open radial control loop operation.

The preset parameters may, for example comprise one or more of the following parameters: a focus offset, a radial tilt, a spherical aberration (SA), a tangential tilt.

When according to claim 3 the one or more signals comprise signals indicative of the radial error signal and/or indicative of a quality of the radial error signal and/or indicative of a reliability of the radial error signal one possible advantage may be that all indicators of the quality and/or reliability of the radial error signal can be taken into account and hereby e.g. improve the evaluation step.

The one or more signals may be the radial error signal itself. The one or more signals may alternatively or additionally be one or more signals indicative of the radial error signal and/or indicative of a quality of the radial error signal and/or indicative of a reliability of the radial error signal. The indicative signals may e.g. give an indication or a direct specification of a quality and/or a reliability of the radial error signal. A radial error signal with e.g. high quality and high reliability is also referred to as an optimal radial tracking error signal. The signals may therefore e.g. comprise one or more signals such as the following; an asymmetry of a signal, a HF asymmetry of a signal, a HF modulation of a signal, a radial to focus crosstalk level, an amplitude level of a signal, a push-pull amplitude of a signal, a differential phase signal (DPD signal), the focus error signal, a noise level of a signal.

An optimal tracking error signal, or an optimal signal of any of the one or more signals indicative of the radial error signal and/or indicative of a quality of the radial error signal and/or indicative of a reliability of the radial error signal, generally has certain optimal amplitude and/or a certain optimal noise level. The optimal amplitude may be an amplitude level above a certain threshold amplitude level. The optimal noise level may be a level below a certain threshold noise level.

In a case of a push-pull based tracking the optimal tracking error signal should, alternatively or additionally to having optimal amplitude and/or an optimal noise level, as an aim behave like a sine wave. The sine wave describes track crossings.

For a DPD tracking a substantially triangular tracking error signal should, alternatively or additionally to having optimal amplitude and/or an optimal noise level, be an aim for an optimal tracking error signal.

When according to claim 4, determining and setting all the parameter(s) necessary in order to obtain the optimal radial tracking error signal a possible advantage may be that possibly no new setting(s) necessarily have to be provided after closing the radial control loop.

Generally, setting the parameters may comprise setting the parameters in the focus control loop and/or in other parts of the optical drive system.

The optional features as defined by claims 5-7 may be advantageous since hereby a simple but yet effective and fast determination of an optimal setting is provided. The evaluation may comprise that the optimal setting of the parameter(s) is determined when a maximum amplitude level is present and/or a minimum noise level is present.

According to a second aspect of the invention there is provided a computer readable code adapted to perform the method steps of the first aspect.

According to the third aspect of the invention there is provided an optical drive system for reading and/or writing information from and/or to an optical carrier, the optical drive system comprising

generation means for generating one or more signals being dependent on the one or more preset parameters and

evaluating means for evaluating the one or more signals and

varying means for varying one or more of the preset parameters and

determining means adapted for determining an optimal setting of the one or more preset parameters in response to the one or more signals and hereby to obtain an optimal radial tracking error signal before closing a radial control loop.

In general the various aspects of the invention may be combined and coupled in any way possible within the scope of the invention. Similarly the advantages described for one aspect of the invention may be used for the other aspects.

These and other aspects, features and/or advantages of the invention will be apparent from and elucidated with reference to the embodiments described hereinafter.

Embodiments of the invention will be described, by way of example only, with reference to the drawings, in which

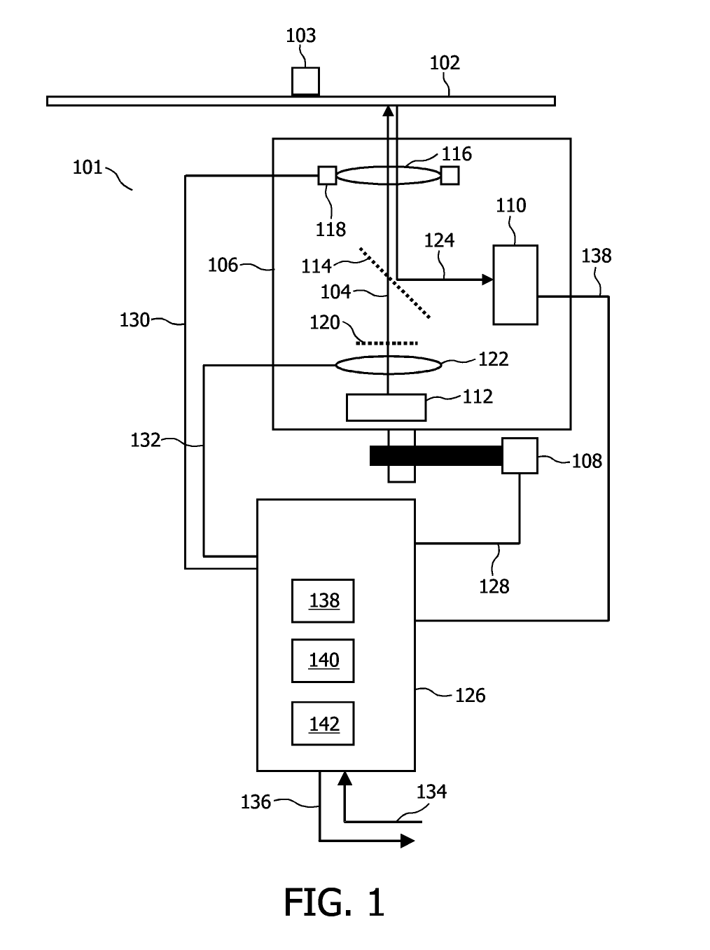

FIG. 1 is a schematic block diagram of an embodiment of an optical drive according to the invention,

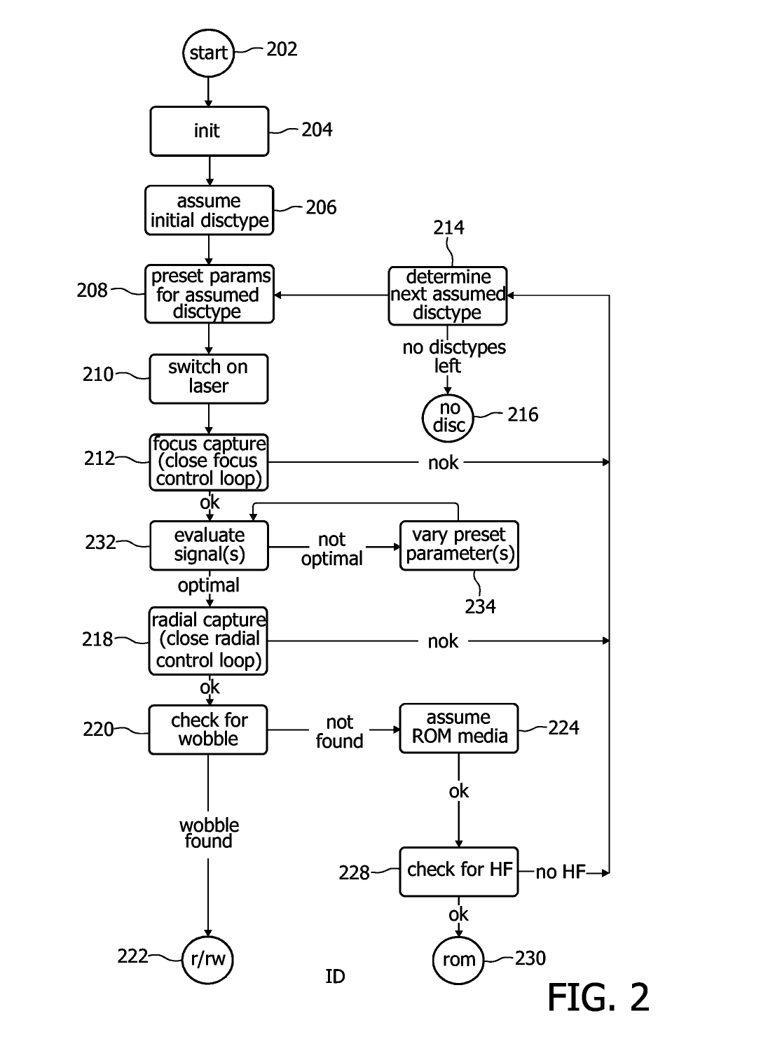

FIG. 2 is a flowchart of a start up flow in accordance with the present invention.

An embodiment of an apparatus in accordance with the present invention is illustrated in FIG. 1 where a schematic diagram of an optical drive according to the invention is shown.

The optical carrier 102 may, when associated with the optical drive 101, be fixed and rotated by holding and rotating means 103. The carrier 102 comprises a material suitable for read only carriers and/or a material suitable for recording information by means of a radiation beam 104.

The apparatus comprises an optical head 106, sometimes called an optical pick-up unit (OPU), the optical head 106 being displaceable by optical head actuation means 108, e.g. an electric stepping motor. The optical head 106 comprises a photodetection system 110, a radiation source 112, a beam splitter 114, an objective lens 116, and lens displacement means 118 capable of displacing the lens 116 both in a radial direction of the carrier 102 and in the focus direction (axial direction). The optical head 106 may also comprise beam grating means 120, such as a grating or a holographic pattern that is capable of grating the radiation beam 104 into e.g. three components for use in a three spot differential push-pull radial tracking, or any other applicable control method.

Furthermore the optical head may also comprise a means to compensate for spherical aberration. The means for compensating spherical aberration is either provided by a movable collimator lens 122 or by a liquid crystal element (not shown). In the example of the liquid crystal element the liquid crystal element is provided with means for e.g. adaptation of the phase of the light in order to compensate for spherical aberration.

For clarity reasons, the radiation beam 104 is shown as a single beam after passing through the beam splitting means 120, but the beam may comprise more than one beam. Similarly, the radiation 124 reflected may also comprise more than one component, e.g. three beams and diffractions thereof, but only one beam 124 is shown in FIG. 1 for clarity.

The function of the photodetection system 110 is to convert radiation 124 reflected from the carrier 102 into electrical signals. Thus, the photo detection system 110 may comprise several photo detectors capable of generating one or more electric output signals. The photo detectors are normally arranged spatially to one another, and with a sufficient time resolution so as to enable detection of error signals i.e. focus error FE signals and radial tracking error RE signals, such as a push pull PP signal obtained from a segmented photo detector.

The radiation source 112 for emitting a radiation beam or a light beam 104 can for example be a semiconductor laser with a variable power, possibly also with variable wavelength of radiation. Alternatively, the radiation source 112 may comprise more than one laser.

The optical head 106 is optically arranged so that the radiation beam 104 is directed to the optical carrier 102 via a beam splitter 114, and an objective lens 116. Radiation 124 reflected from the carrier 102 is collected by the objective lens 116 and, after passing through the beam splitter 114, falls on a photo detection system 110 which converts the incident radiation 124 to electric output signals as described above.

As the invention is generally useable for all optical drive systems having a control loop for obtaining axial and/or radial tracking of one or more beam spot(s) provided by one or more radiation beam(s) it is emphasized that the above described optical drive system is only an example of a drive system which may be operated according to the present invention.

In processor 126 a commonly known servomechanism is operated by usage of control means such as one or more PID (proportional-integral-differential) control means.

As indicated by the line 138 the processor 126 receives and analyses signal(s) from the photo detection means 110 and the focus error signal (FE) and radial tracking error signal (RE) are generated. The signals from the photo detection system is depending on e.g. the characteristics of the optical carrier associated in the drive, the optical system itself and one or more preset parameters set in the optical drive system. These parameters may be set in the processor 126.

The processor 126 can also output control signals to the actuation means 108, the lens displacement means 118, the means for displacing the means for obtaining a substantially collimated radiation beam 122, as schematically illustrated in FIG. 1 with the lines 128, 130 and 132 respectively. Similarly, the processor 126 can receive data, indicated at 134, and the processor 126 may output data e.g. from the reading process as indicated at 136 or to or from the means for rotating 103 the carrier and/or the radiation source 112.

The processor 126 is for instance applied for controlling the radial position and focus position of the radiation beam 104 on the carrier 102.

The control of the radial position by e.g. the processor 126 is provided in accordance with parameters set in the optical system. The radial control loop may comprise all means for controlling the radial tracking such as one or more of the means that the processor may output control signals to and any other means which may have an effect on the radial tracking. The radial control loop furthermore comprises the photo detection means 110 and the processor 126. Similarly the focus control loop may comprise all means for controlling the focus of the radiation on the carrier such as one or more of the means that the processor may output control signals to and any other means that may have an effect on the focus. The focus control loop furthermore comprises the photo detection means 110 and the processor 126.

Thus, the photo detector system may be denoted a generation means for generating one or more signals being dependent on e.g. the one or more preset parameters. The preset parameters are parameters useable to adjust the performance of the optical drive in response to characteristics of the optical drive and/or in response to characteristics of the optical carrier associated with the optical drive.

The processor 126 may comprises evaluating means 138 for evaluating the one or more signals and varying means 140 for varying one or more of the preset parameters and determining means 142 adapted for determining and setting an optimal setting of the one or more preset parameters in response to the one or more signals and hereby to obtain an optimal radial tracking error signal before closing the radial control loop.

FIG. 2 shows a flowchart of a start up flow of an optical drive in accordance with the invention where start up of the optical drive is provided in 202 and followed by initialization in 204 and the drive assuming an initial carrier type in 206. Hereafter follows a presetting of parameters 208 for the assumed carrier type which is followed by a switch on of the radiation source such as a laser and the capture of focus 212 when closing the focus control loop.

If the focus capture is not satisfying certain one or more criteria (nok), i.e. e.g. due to the focus error signal not fulfilling certain of the one or more criteria the start up procedure will determine a next carrier type in 214. If all carrier types have been assumed and no carrier types are left it will be determined by the optical drive that no carrier 216 is associated with the optical drive. If all the carrier types have not been tried the start up procedure will set the parameters for the carrier type now assumed and go back to 208.

If the focus capture is OK, e.g. due to the focus error signal fulfilling certain of the one or more criteria, the one or more signals derived from the signal(s) generated by e.g. the photo detector system 110 and received by the processor 126 is evaluated 232 in the processor.

If it is determined that the signals received are evaluated 232 as being not optimal, one or more of the preset parameters are varied in 234. An optimal tracking error signal, or any of the one or more signals indicative of the radial error signal and/or indicative of a quality of the radial error signal and/or indicative of a reliability of the radial error signal, generally has certain optimal amplitude and/or a certain optimal noise level. The optimal amplitude may be an amplitude level above a certain threshold amplitude level. The optimal noise level may be a level below a certain threshold noise level.

One parameter may be varied alone one or more times and/or several parameters may be varied at the same time one or more times. For each variation or for a number of variations the one or more signals are evaluated with the new setting of the parameter(s) and this iteration may be run one or more times.

If based on the evaluation it is decided that it would be of benefit for the radial tracking to adjust e.g. a collimator lens, the processor sends a control signal to the displacement means of the collimator or to the means for providing a collimated and/or parallel beam. The control signal may e.g. be to adjust the position of the collimator lens from the already set position and by the adjustment to provide beams that are not completely parallel e.g. in order to compensate for spherical aberration when e.g. a two layer optical carrier is associated with the optical drive.

If it is decided by the processor that it would be of benefit to vary a focus offset an offset is injected into the focus PID loop just before the PID. Below a table is showing an example of which parameters may be varied and which signals may be evaluated for different assumed types of carriers.

| Assumed | | | Typical applied |
|---|---|---|---|
| carrier type | Parameter | Signal | variation |
| BD | Focus offset | PP signal | +/−XXX nm |
| BD | SA (spherical | PP signal | +/−XX μm |
| | aberration) | | |
| BD | SA | HF signal amplitude | +/−XX μm |
| BD | SA | FE signal | +/−XX μm |
| DVD | Focus offset | PP signal | +/−XXX nm |
| CD | None | Not applicable | Not applicable |

X is a number from zero to nine. The table is an example and therefore further or less parameters may be varied and further or less signal or derivates of the signals may be evaluated for the different parameter(s) and/or the different assumed carrier types. Similarly, it may be the above signals or derivates of the signals that is evaluated. The derivates may be such as a mean value of a noise level, a slope of a mean of a noise level of a signal. The signals may e.g. be evaluated during one or more revolutions of the carrier.

If the radial capture is still not OK, and no optimal setting could be found and e.g. a maximum number of iterations has been reached, the start up procedure of the optical drive will go back to assuming another carrier type in 214 as also described when the focus capture was not satisfactory. Alternatively or additionally if e.g. it is observed during the evaluation that e.g. the amplitude is too low, it may be concluded that the means for providing a radiation beam is not suitable for the optical carrier associated with the optical drive.

When it is determined that the radial error signal is optimal the radial control loop is closed 218 with the new setting of the parameter(s) and the start up procedure of the optical drive will check if a wobble signal is found 220.

If the wobble signal is found it is determined in 222 that a media of the assumed type that is both readable and writeable is present in the optical drive. If the wobble signal is not found it is assumed that a read only memory (ROM) media 224 is present in the optical drive. Then the parameters are set for a ROM media and the radial error signal is checked for High Frequencies (HF). If HF is present the media is a ROM, if not, then the start up procedure will go back to 214 and determine the next assumed carrier type as also described when the focus capture was not satisfactory.

When in the present context it is written that the start up procedure will provide certain steps it must be understood that it is mostly the control means of the optical drive such as the processor 126 that provides or activates the different steps.

Although the present invention has been described in connection with preferred embodiments, it is not intended to be limited to the specific form set forth herein. Rather, the scope of the present invention is limited only by the accompanying claims.

In the description, certain specific details of the disclosed embodiment are set forth for purposes of explanation rather than limitation, so as to provide a clear and thorough understanding of the present invention. However, it should be understood readily by those skilled in this art, that the present invention may be practized in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. A method of optimizing a radial tracking error signal of an optical drive (101), the method comprising the steps of
generating one or more signals, the signals being dependent on one or more preset parameters and
evaluating (232) the one or more signals and
varying (234) a setting of the one or more of the preset parameters and
determining an optimal setting of the one or more preset parameters and setting the parameters to the optimal setting in response to the one or more signals before closing the radial control loop (218) and before an optical carrier recognition and hereby
obtaining an optimal radial tracking error signal before closing a radial control loop (218) and before optical carrier (102) recognition.

2. The method of optimizing a radial tracking error signal of an optical drive (101) according to claim 1, wherein the one or more preset parameters comprises one or more parameters useable to adjust the performance of the optical drive in response to characteristics of the optical drive and/or in response to characteristics of an optical carrier (102) associated with the optical drive.

3. The method of optimizing a radial tracking error signal of an optical drive (101) according to claim 1, wherein the one or more signals is indicative of the radial error signal and/or indicative of a quality of the radial error signal and/or indicative of a reliability of the radial error signal.

4. The method of optimizing a radial tracking error signal of an optical drive (101) according to claim 1, wherein determining the optimal setting of the one or more preset parameters and setting the parameters to the optimal setting in response to the one or more signals comprises determining and setting all the parameter(s) necessary in order to obtain the optimal radial tracking error signal.

5. The method of optimizing a radial tracking error signal of an optical drive (101) according to claim 1, wherein the optimal setting of one or more parameters is determined in response to a comparison of the one or more signals or derivates of the one or more signals with one or more reference signals or derivates of reference signals.

6. The method of optimizing a radial tracking error signal of an optical drive (101) according to claim 1, wherein the optimal setting of one or more parameters is determined in response to an evaluation of one or more of the following levels of the signal(s); an amplitude level of the signal, a noise level of the signal.

7. The method of optimizing a radial tracking error signal of an optical drive (101) according to claim 1, wherein the evaluation comprises comparing one or more of the signals or derivates of the signals with predetermined threshold levels.

8. A computer readable code adapted to perform the method steps according to claim 1.

9. An optical drive system for reading and/or writing information from and/or to an optical carrier (102), the optical drive (101) system comprising
generation means (110) for generating one or more signals being dependent on the one or more preset parameters and
evaluating means (138) for evaluating the one or more signals and
varying means (140) for varying one or more of the preset parameters and
determining means (142) adapted for determining an optimal setting of the one or more preset parameters and setting the parameters to the optimal setting in response to the one or more signals before closing the radial control loop (218) and before an optical carrier (102) recognition and hereby obtaining an optimal radial tracking error signal before closing a radial control loop (218) and before optical carrier recognition.
